(19) United States
(12) Patent Application Publication
(10) Pub. No.: US 2016/0265291 A1
(43) Pub. Date: Sep. 15, 2016

(54) Dehydration and/or Heating of Drilling Mud or Mixed Material

(71) Applicant: John E. Powell, JR., San Antonio, TX (US)

(72) Inventor: John E. Powell, JR., San Antonio, TX (US)

(21) Appl. No.: 15/069,864

(22) Filed: Mar. 14, 2016

Related U.S. Application Data
(60) Provisional application No. 62/132,406, filed on Mar. 12, 2015.

(51) Int. Cl. E21B 21/06; B01D 1/00; C02F 1/04

(52) U.S. Cl. CPC E21B 21/063; C02F 1/048; B01D 1/0041; C02F 2103/10

(57) ABSTRACT

Heat is applied in a closed multifunctional container system which dehydrates and/or decontaminates, and processes mixed materials (such as drilling mud) deposited within the container. The disclosed container is used for material collection, transport, treatment and transport to final dehydrated/decontamination destination. In the container, the material may be treated with a single step heating or dehydration process accomplished by inserting a heating element into the container designed for the heat to indirectly contact the mixed material to heat and cause water to vapor off the product and/or contaminates to be sterilized from earth. After treatment the volume of the material has had the water percentage reduced or contaminates removed and is now ready for disposal or other use where a high percentage of water or other containment(s) are undesirable.

### STATEMENTS REGARDING FEDERALLY SPONSORED RESEARCH OR DEVELOPMENT

Not Applicable.

### NAMES OF THE PARTIES TO A JOINT RESEARCH AGREEMENT

Not Applicable.

### REFERENCE TO A “SEQUENCE LISTING”, A TABLE, OR A COMPUTER PROGRAM

Not Applicable.

### BACKGROUND

### Technical Field

The subject matter generally relates to systems and techniques in the field of dehydration and heating materials.

Drilling rigs are currently under increasing regulation to not use open pits to contain drilling mud and later dispose of the drilling mud after drying the mud. In the past, one conventional practice would be to simply back fill the drilling mud in the same pit it was circulated to. If the drilling mud was too wet to simply cap over, then fingers were dug to dissipate the mud over a larger area. Other known or conventional mechanisms to dehydrate the mud often require multiple handling steps and processes where the material may be increased in bulk/volume. For example, a current market mechanism to dry mud involves mixing a chemical drying or bulking material to absorb water and then contain the material for transport and haul the mud mix, now larger in volume, for disposal. The volume of the product, having increased with the bulking agent and entrapped water, also leads to higher transportation and handling costs. Other current dehydration methods involve using available soils, lime, floor dry, wood chips with the single commonality of keeping the water in place and adding material to “soak up” or absorb the water. The solution almost always inevitably adds material bulk to the original mud for land fill disposal. Other methods to remove water include: centrifuge, de-sanders and shale shakers—these are mechanical means and are also costly and involve multiple handling steps of the material.

Other soil, earth or terra firma (which may or may not include rocks) can become contaminated with hydrocarbons. One example would be a fuel station containing underground fuel storage tanks in which the storage tanks leak hydrocarbons into the surrounding soil, earth or terra firma (collectively referred to below as ‘earth’). Contaminated earth requires remediation.

Drilling mud may include naturally occurring earth, and/or drilling fluid which may include water and/or additives (non-synthetic and/or synthetic). Drilling mud may or may not be considered contaminated depending upon whether it has become impregnated with contaminants beyond a threshold level. Therefore, drilling mud may require dehydration, heating and/or remediation of contaminants. In other words, ‘undesirables’ may be defined as fluid(s) and/or contaminant(s).

Thus, there exists a need for an improved system and method for dehydration and transport of mixed materials (‘mixed materials’ defined here as drilling mud or earth and which may or may not be contaminated) and/or which can decontaminate mixed materials for remediation.

### BRIEF SUMMARY

Heat is applied in a closed multifunctional container system which dehydrates and/or decontaminates, and processes mixed materials (such as drilling mud) deposited within the container. The disclosed container may be used for mud or mixed material collection, treatment and transport to and from desired locations, including to the final dehydrated/decontamination destination or site containment. In the container, the mixed material may be treated with a single step dehydration and/or decontamination process accomplished by inserting a heating element into the container designed for the heat to indirectly contact the mixed material to heat and cause water or other contaminates to evaporate off the final or treated product and/or contaminates to be sterilized from the earth. Internal paddles or a screw auger or other mechanical mechanism can be used to move, agitate or mix the mixed material around to help in heat and treatment material distribution. After treatment, the volume of the material has had the water, contaminates and any other material(s) that are successful with heat stimulation reduced or removed and is now ready for disposal or other use where a high percentage of water containment or contaminates is undesirable. The disclosed embodiments can also control treatment temperatures that will also allow on site land fill use (depending on local regulatory compliance) as well as use to decontaminate soils for remediation.

### BRIEF DESCRIPTION OF THE FIGURES

The exemplary embodiments may be better understood, and numerous objects, features, and advantages made apparent to those skilled in the art by referencing the accompanying drawings. These drawings are used to illustrate only exemplary embodiments, and are not to be considered limiting of its scope, for the disclosure may admit to other equally effective exemplary embodiments. The figures are not necessarily to scale and certain features and certain views of the figures may be shown exaggerated in scale or in schematic in the interest of clarity and conciseness.

FIG. 1 depicts a side view of an exemplary embodiment of an improved container or box holding mixed material or drilling mud for treatment or disposal.

FIG. 2 depicts an internal view of an exemplary embodiment of a hot oil truck having a low NOx heating unit.

FIG. 3 depicts an internal schematic view of an exemplary embodiment of a container for dehydrating and transporting mixed material.

FIG. 4 depicts a perspective view of an exemplary embodiment of an internal central or receiving tube for a heating element.

FIG. 5 depicts an exploded schematic view of an exemplary embodiment of an improved container and an exemplary embodiment of a treatment skid.

FIG. 6 depicts a top view of dehydrated land refillable product, treated product or brick accomplished by the exemplary embodiments described herein.

FIG. 7 depicts an enlarged top view of the dehydrated land refillable product, treated product or brick of FIG. 6.

FIG. 8 depicts exemplary embodiments of a treatment skid and a heating or thermal element partially inserted into an internal receiver tube.

FIG. 9 depicts an exemplary embodiment of a heating element partially inserted into a receiver tube.

FIG. 10 depicts an exemplary embodiment of a heating element fully inserted into a receiver tube.

FIG. 11 depicts an exemplary embodiment of an exhaust, exhaust stack or vapor exhaust system as part of a container for dehydrating and transporting material.

FIG. 12 depicts an exploded perspective view of an alternative exemplary embodiment of an improved container with internal paddle(s) and sub floor with area for inserted heating element and an exemplary embodiment of a treatment skid with mechanical energy drive or motor for paddle mixers.

FIG. 13 depicts a side view of an alternative exemplary embodiment of an improved container with internal paddle(s) and sub floor with area for a fully inserted heating element and a mechanical energy drive or motor for paddle mixers.

FIG. 14 depicts a side view of a schematic of an alternative exemplary embodiment of an improved container with a heating coil system and a thermal oil bed.

FIG. 15 depicts a top view of an alternative exemplary embodiment of a container.

FIG. 16 depicts a cross-section view of an alternative exemplary embodiment of a container along line 16-16 of FIG. 15.

FIG. 17 depicts a perspective view of an exemplary embodiment of a container having a dome.

FIG. 18 depicts a perspective view of an exemplary embodiment of a heating element.

FIG. 19 depicts a perspective view of an exemplary embodiment of a heating element having thermal energy supplied.

FIG. 20 depicts an end perspective view of an alternative exemplary embodiment of an improved container.

FIG. 21 depicts a perspective view of an exemplary embodiment of an improved container with internal paddle(s) and sub floor with area for inserting a heating element and an exemplary embodiment of a treatment skid with mechanical energy drive or motor for paddle mixers with the container in a position where the heating element is not inserted into the container.

FIG. 22 is similar to FIG. 21 but showing the container without sidewalls and showing the container in position on the skid with the heating element inserted into the container.

FIG. 23 is a view similar to FIG. 22 with the perspective shown from below.

FIG. 24 is a top view of the embodiment of FIGS. 22-23 shown in section to show the interior of the container.

FIG. 25 is a side elevation view of the embodiment of FIGS. 22-23.

FIG. 26 is a view similar to FIG. 24 only not in section.

FIG. 27 is a view similar to FIG. 25.

FIG. 28 is a side elevation view of a truck loading or unloading a container to/from a skid.

FIG. 29 depicts a perspective view of an exemplary embodiment of a mode of heating a container.

FIG. 30 depicts a perspective view of another exemplary embodiment of a mode of heating a container.

### DETAILED DESCRIPTION OF THE EXEMPLARY EMBODIMENT(S)

The description that follows includes exemplary apparatus, methods, techniques, and instruction sequences that embody techniques of the inventive subject matter. However, it is understood that the described exemplary embodiments may be practiced without these specific details.

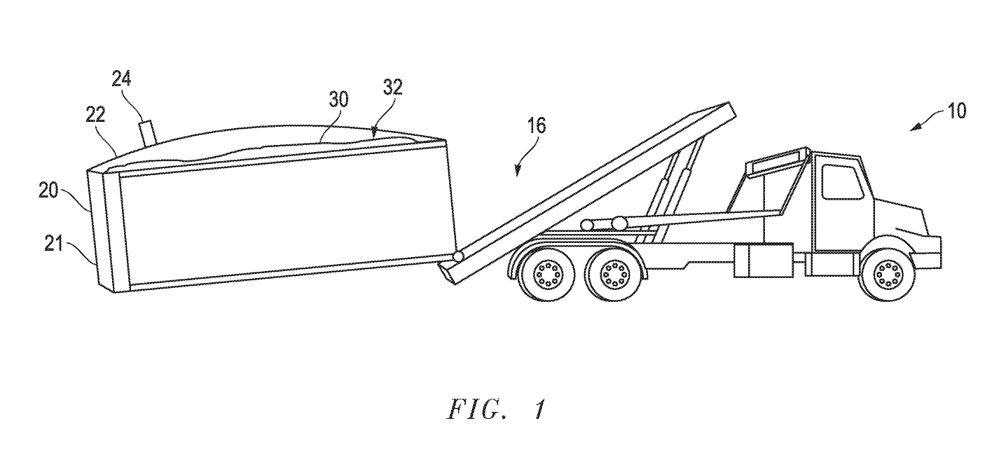

FIG. 1 depicts a side view of an exemplary embodiment of a roll off container, vessel or box 20 having mixed material or drilling mud (or the like) 30 for the purpose of treatment or disposal. The container 20 may be coupled to a truck 10, and may have roll-off means, mechanism or skid 16 to easily transport the container from destination to destination. The vessel, box or container 20 includes a dome 22 to protect a volume of drilling mud or mixed material 30 within. The drilling mud 30 (or other material, such as by way of example only, soil) may be mixed with a volume of fluid/liquid or water 32 which needs to be removed for proper disposal (or other use). The drilling mud or other material 30 may also need to be decontaminated through heating. The containers 20 are able to accept the mud 30 in any potential water percentage 32. These same containers 20 have an internal hollow receiver tube (or barrier) 28 where a thermal heating element 26 (as illustrated in FIGS. 3-5) can be inserted to dry out or evaporate liquid from the material 30 by heating the material 30 past the boiling point of the fluid or water 32 to be removed. The same container 20 can then have the heating element 26 slid out of or removed from the tube 28. The container 20 can then be transported to a land fill, or other disposal or desired area. The drilling mud or mixed material 30, after the dehydration process, becomes a land fill acceptable product, treated product or brick 34 and is easily removed from the container 20 by the opening of a hatch or door 21 and sliding dehydrated material or brick 34 out of the container 20. The drilling mud or mixed material 30 is not increased with bulk water 32 tying up products and keeping the water 32 tied into the mud or material 30 as part of the treatment process. The removed water 32 is returned to the environment as water vapor through exhaust stack 24 on top of the dome 22. Further, as discussed above, the container or box 20 is able to contain, treat and transport in one vessel.

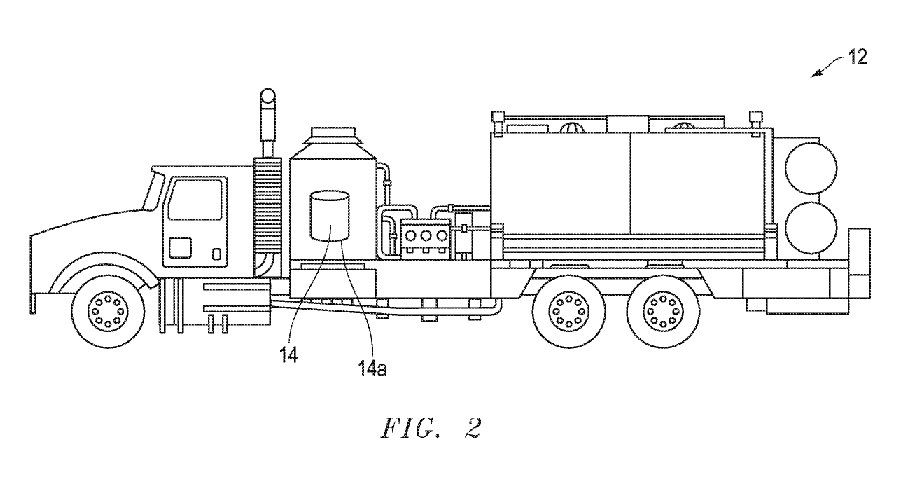

FIG. 2 depicts an internal view of an exemplary embodiment of a hot oil truck 12 having a heating source or unit 14. The heating source or unit 14 may be a low nitrogen oxide (or NOx) solution unit 14a, but in alternate embodiments may include all-electric heating elements or other power supplies, including electric generators, propane units and maintaining another heating unit or element at a designated permanent treatment place.

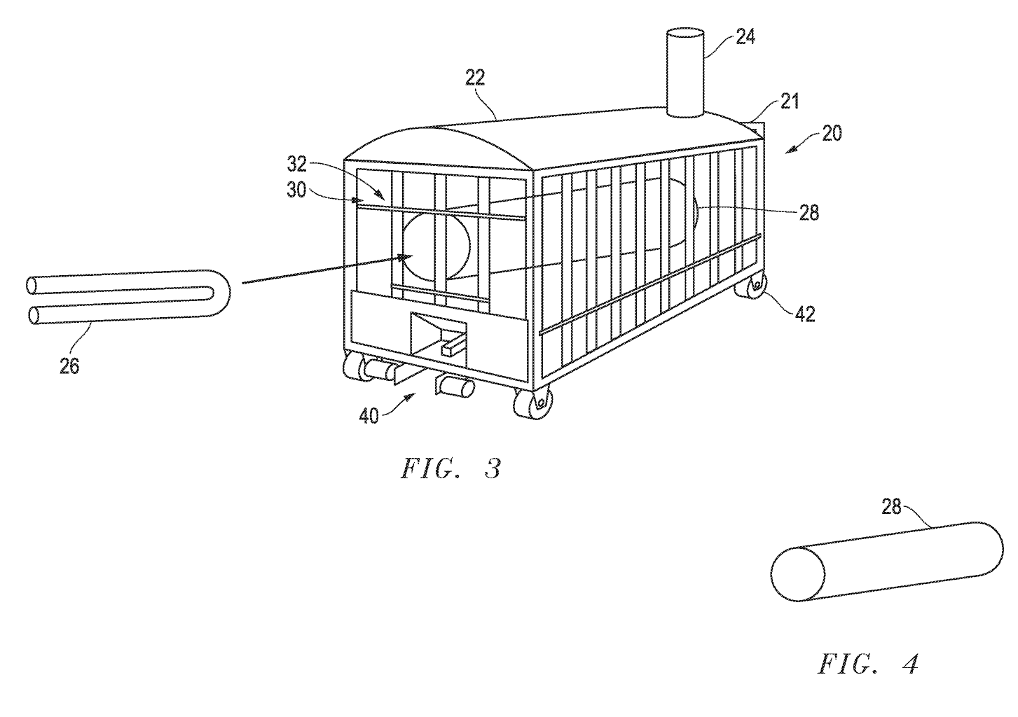

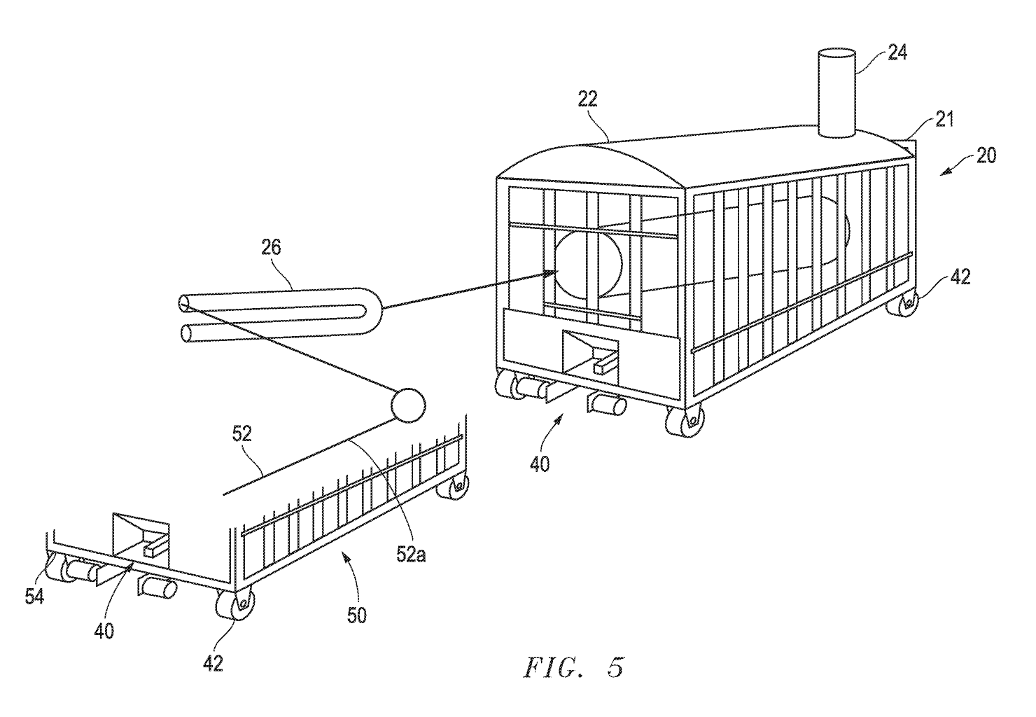

FIG. 3 depicts an internal view of an exemplary embodiment of a container 20 for dehydrating and transporting mixed material or drilling mud 30. FIG. 4 depicts a perspective view of an exemplary embodiment of an internal central or receiving tube 28 for a heating element 26. The receiver tube 28 is hollow and may be located in the center of the container 20, but may also be elsewhere in the container 20, such as, by way of example only, towards the bottom of the container 20. The container 20 may be a custom engineered container that includes a dome 22 for protection of the drilling mud 30 and a vapor exhaust stack or exhaust 24. The exhaust 24 may be tailored for vapor escape and may include a vapor scrubbing and a water liquid recovery and or escape. Further, the exhaust 24 may be mounted or connected to the dome 22. The heating element 26 may slide into the transport container 20 via the receiver or center tube 28. The heating element 26 is inserted for the dehydration or treatment process and subsequently removed after the process is completed. Moreover, in an alternative exemplary embodiment the heating element 26 and the heating unit 14 may be one and the same. In such alternative embodiments, the heating element 26 may also be a low NOx unit 14a or other heating unit 14 including but not limited to all-electric heating elements or other power supplies, including electric generators, propane units and maintaining another heating unit or element at a designated permanent treatment place. In an exemplary embodiment, the center or receiver tube 28 is fixed in every container 20 in the same place so that the heating element 26 may be easily slid into place with a custom insertion tool or heating element insertion device 52. Further, the container 20 may have sidewalls 29 and a door or hatch 21 at an end of the container for easy unloading or disposal of dehydrated or treated material 34. The container or vessel 20 may also have latches or couplers 40 at both the front end and the back end for aligning and coupling to a treatment skid 50 (shown in FIG. 5), and other vehicles or locations, and may also feature wheels 42 for ease of transportation or positioning for alignment. The container defines as interior 36.

FIG. 5 depicts an exploded schematic view of an exemplary embodiment of a container 20 and an exemplary embodiment of a thermal element containing roll off skid or treatment skid 50, which is used to store and transport as well as insert the heating or thermal element 26 into the central or receiving tube 28. The treatment skid 50 may have a trailer or other receptacle 54 to which a heating element insertion device 52 is coupled at one end of the heating element insertion device 52. At the other end, the heating element insertion device 52 is connected to the heating element 26. The heating element insertion device 52 may be an arm 52a which is able to maneuver and pivot as necessary to safely insert and retrieve the heating element 26 into and out of the central or receiving tube 28. Other methods of inserting and removing a heating element 26 are possible. The treatment skid 50 may also have wheels 42 (i.e. the wheels could be mounted to the container 20, to the skid 50, or both) for ease of transport as well as latches or couplers 40 at both a front end and a back end for coupling to the container 20, a truck 10 or hot oil truck 12 as desired.

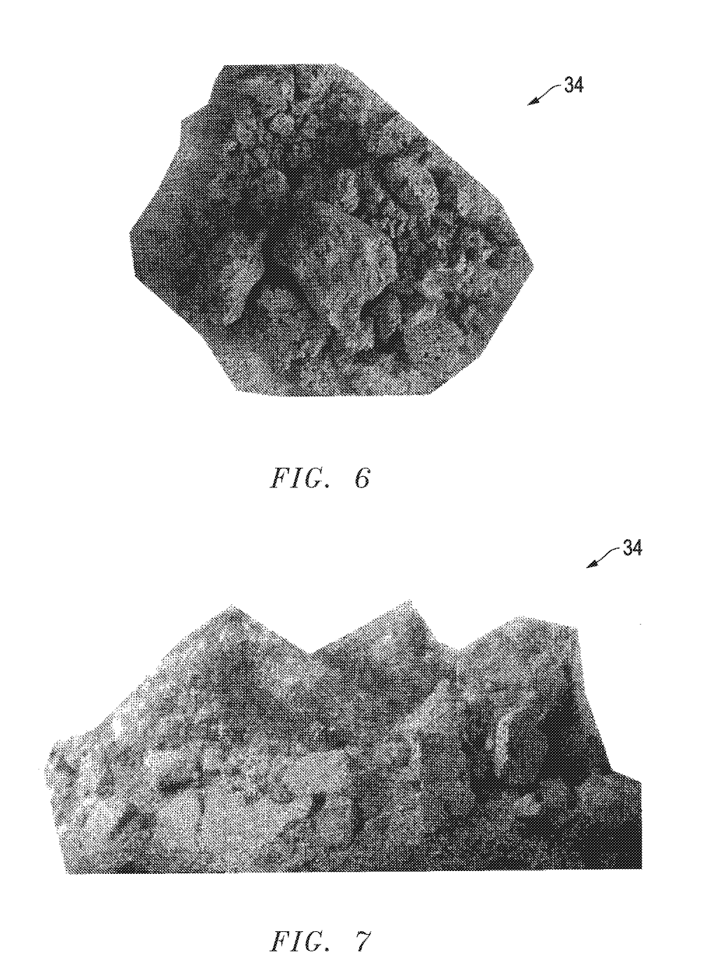

FIGS. 6 and 7 depict a top view of dehydrated land refillable product, desired product or brick 34 as accomplished by the dehydration process described herein without encapsulating entrained water or fluid 32 through any chemical or bulking agents. The brick 34 in FIGS. 6 and 7 is the result of drilling mud or mixed material 30 being heated in a container 20 through a heating element 26 that has reached a temperature of at least 350° F. Other temperatures are possible, so long as the fluid or water 32 evaporates from the material 30. A paint filter liquids test may be used to test whether the treated material or brick 34 has achieved the proper level of dehydration to be acceptable for land fill disposal.

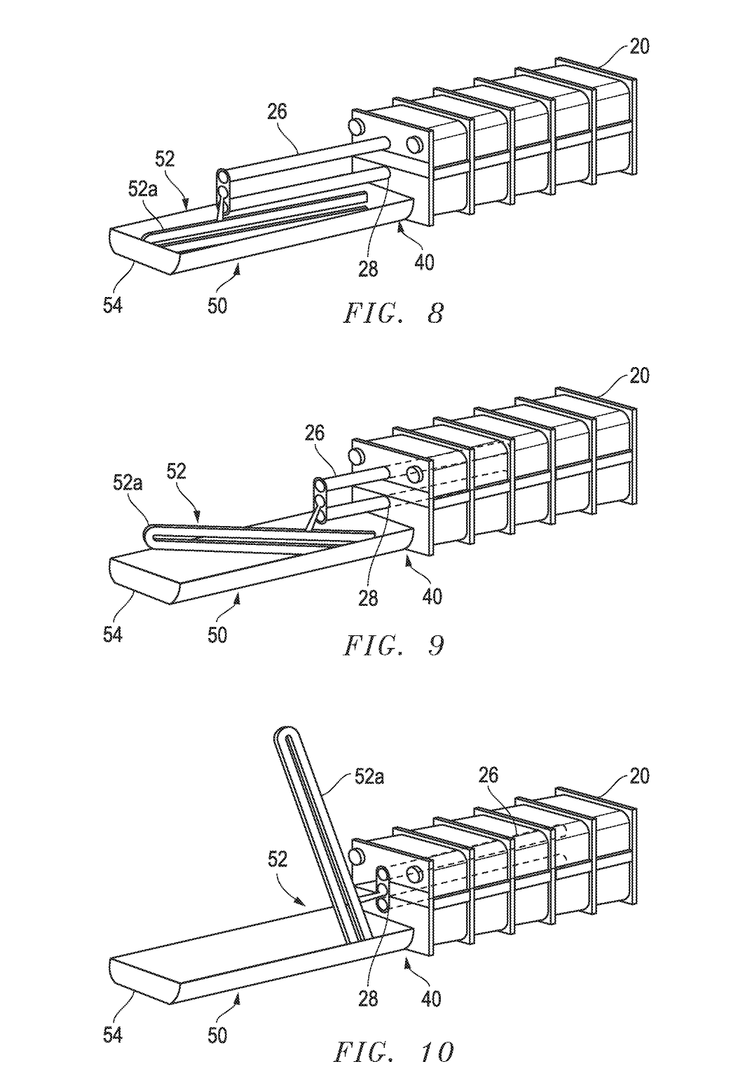

FIG. 8-10 depicts exemplary embodiments of a treatment skid 50 holding a heating or thermal element 26 which is progressively inserted into a receiver tube 28 via a heating element insertion device 52. FIGS. 8 and 9 show a partial insertion of the heating element 26, while in FIG. 10, the heating element 26 is fully inserted into the receiver tube 28. As illustrated, the heating element insertion device 52 may be an articulable arm 52a which can articulate, pivot or turn to insert or push and retrieve or pull heating element 26 to and from the receiver tube 28. The heating element 26 and heating element insertion device 52 may also rest on a trailer or receptacle 54 to store the heating element 26 when not in use, or in between treatments. The treatment skid 50 is able to align or line up with the receiver tube 28 and container 20 so that the heating element 26 can be easily slid in for treatment after coupling to the container 20 (see FIG. 5).

FIG. 11 depicts an exemplary embodiment of an exhaust or vapor exhaust stack 24 as part of an improved container 20 for dehydrating and transporting material 30. The vapor exhaust stack 24 may have an inlet 62 connected or mounted to the dome 22 covering the container 20. The vapor exhaust stack 24 allows gases or vapors to escape or leave the otherwise closed container system 20 through an outlet 60 as the material or mud 30 is being treated. The vapor exhaust stack 24 may also have a filter or mist eliminator pad 66 within so as to screen or clean the gases leaving the exhaust system 24 and prevents exhaust material, excessive moisture/mist, particulate, debris or other undesirable substances from entering into the environment through the outlet 60. The undesirable substances may instead leave the vapor exhaust stack 24 through a material waste outlet 64, which allows the excessive moisture, or undesirable substances or debris to be directed to a separate location for removal or treatment. The improved container 20 may include an air monitoring system/sensors 68 in connection with the stack exhaust 24. The stack exhaust 24 may have safe fluid recovery and the heating unit 14 and/or heating element 26 may include a shut-down mechanism (not illustrated) in response to a signal or other feedback from the air monitoring system 68. The shut-down mechanism of the heating unit 14 and/or heating element 26 may be a valve (not illustrated) which shuts the fuel source off to said heating unit 14 and/or heating element 26. The air monitoring system 68 may also include detection of a wind direction of the environment.

FIG. 12 depicts an exploded perspective view of an alternative exemplary embodiment of an improved container 20. The improved container 20 of FIG. 12 features internal paddle(s), mixer(s) or paddle mixer(s) 23 and a floor or false floor, bottom or surface 27 over a subfloor 25a with area 25 for an inserted heating element 26. The exemplary embodiment of the container 20 in FIG. 12 works in conjunction with an alternative exemplary embodiment of a treatment skid 50 having a mechanical motor 56 for each paddle or mixer 23 of the improved container 20 and a heating element 26, which may be a low NOx heating element. FIG. 13 depicts a side view of an alternative exemplary embodiment of an improved container 20 as assembled with the corresponding alternative exemplary embodiment of the treatment skid 50. When the container 20 and the treatment skid 50 are assembled, the motors or mechanical energy drives 56 engage the paddle mixers 23 and the heating element 26 is inserted in the room or area 25 (above subfloor 25a) below the flooring 27. The motors 56 can be activated or turned on to rotate the paddles 23 and break up and agitate the volume of mud or mixed material 30 to evenly disperse treatment or heating throughout the volume of the mud or material 30. The motors 56 can, for example, be variable speed electric motors which can adjust the rotational speed of the paddle(s), mixer(s) or paddle mixer(s) 23 according to, by way of example only, the monitored temperature. The paddle(s), mixer(s) or paddle mixer(s) 23 fold the volume of mixed material 30 in the container 20.

FIG. 14 depicts a side view of a schematic of an alternative exemplary embodiment of an improved container 20 with a heating coil system 70 and a volume, base or bed of liquid, oil or thermal oil 72. In an alternative embodiment, the heating element 26 may be a heating coil system 70 combined with a volume of liquid, oil or thermal oil 72 within the area 25 above floor 25a and covered with the flooring 27. The heating coil system 70 may run back and forth in the liquid bed 72 in area 25 and exit the area 25 for reheating. The heat in the coils 70 heats up the thermal bed 72 and the even heat in the thermal bed 72 now allow heating of the mud 30 above the heating element 26 without any “hot spots”. In an alternate embodiment, the heating coil system 70 may heat the volume of thermal oil 72 external to the area 25. In the alternative exemplary embodiments of FIGS. 15 and 16, the heating coils 70 may operate in the improved container 20 without a thermal oil bed 72 by heating the air or space in area 25 under the flooring 27. The coils 70 of heating element 26 may be, by way of example only, steam coils.

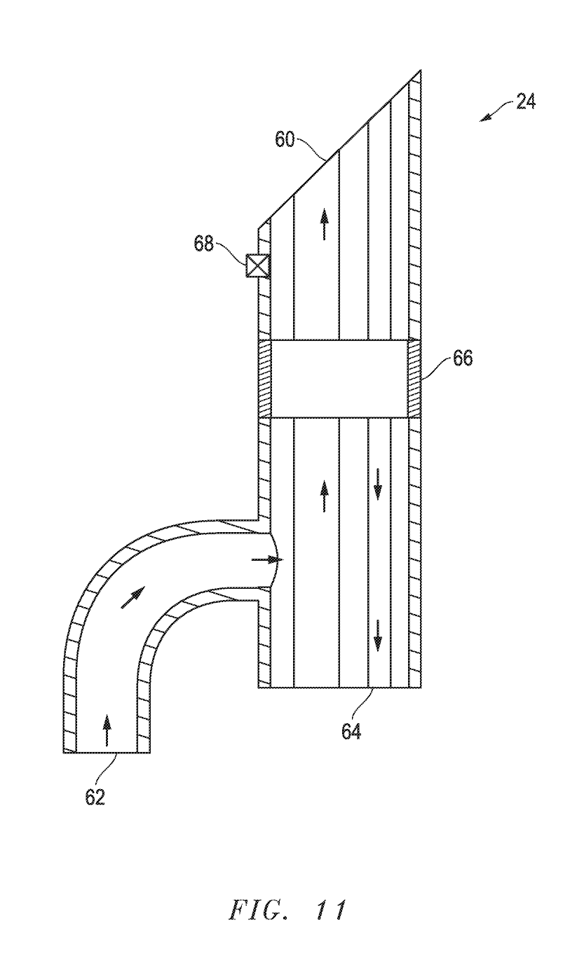

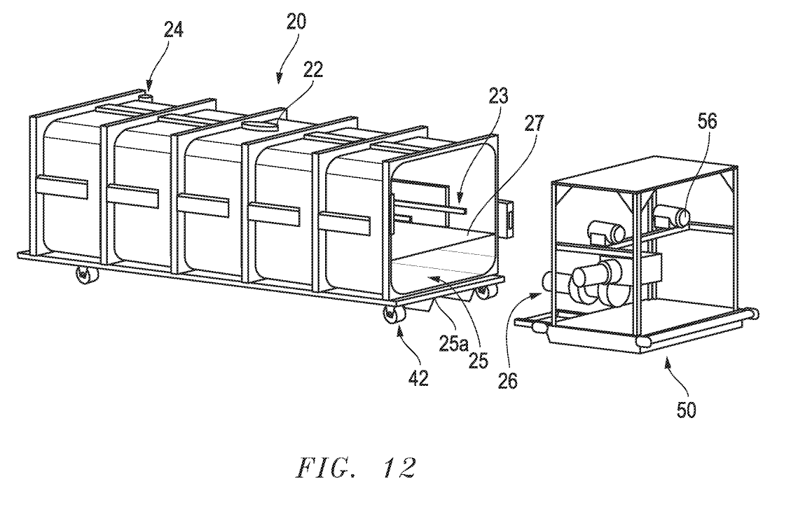

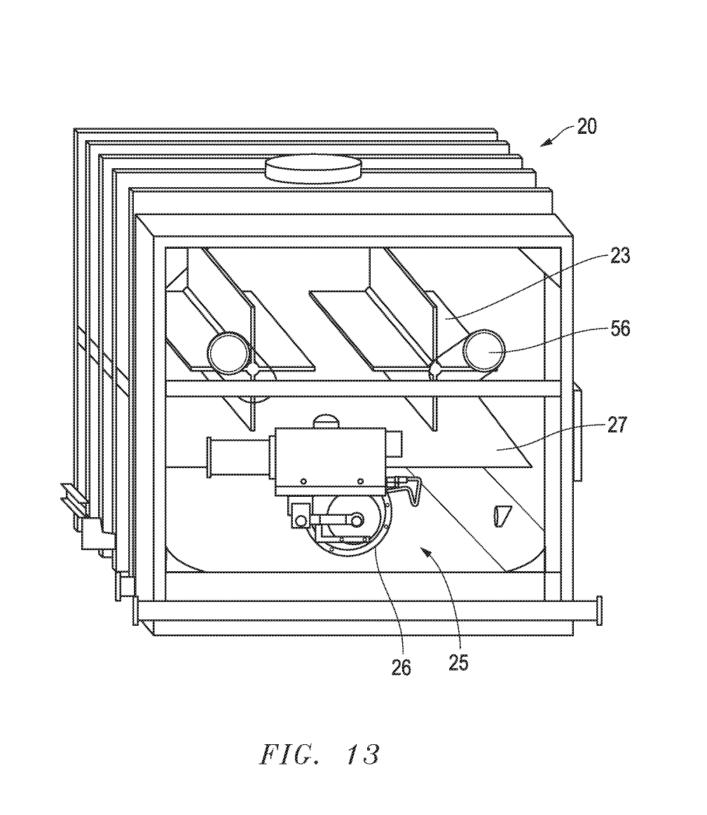

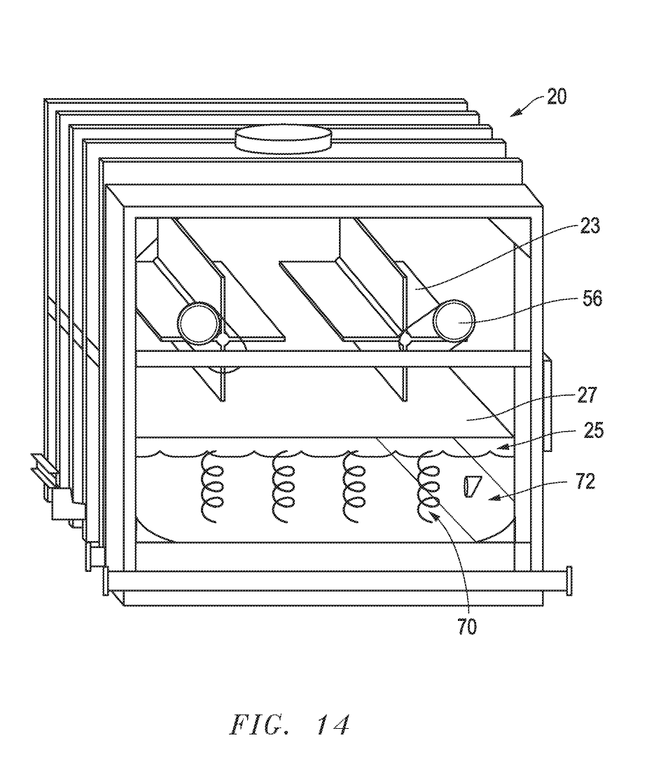

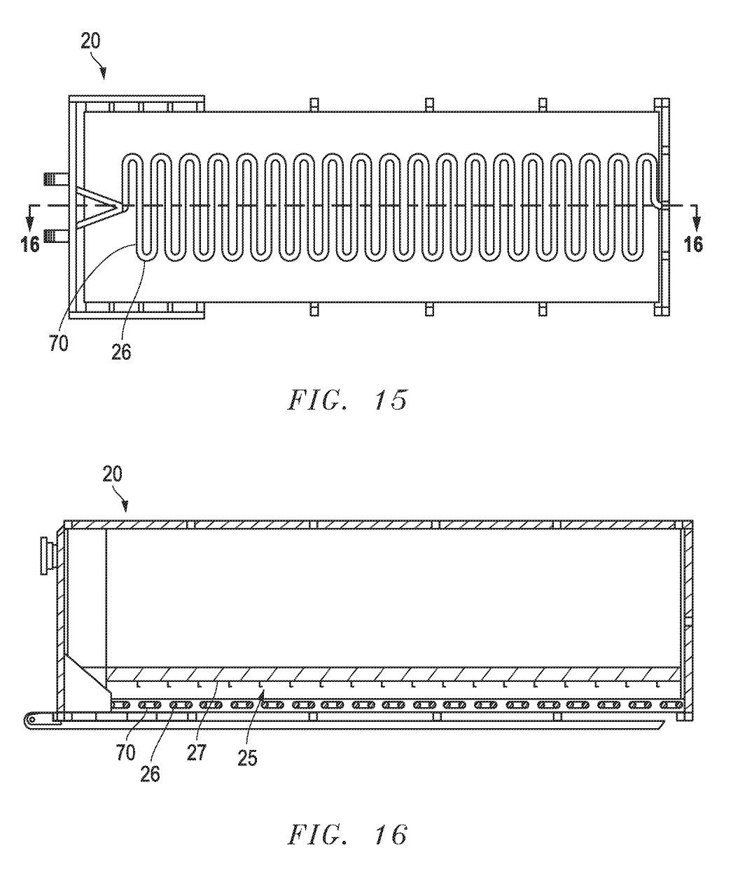

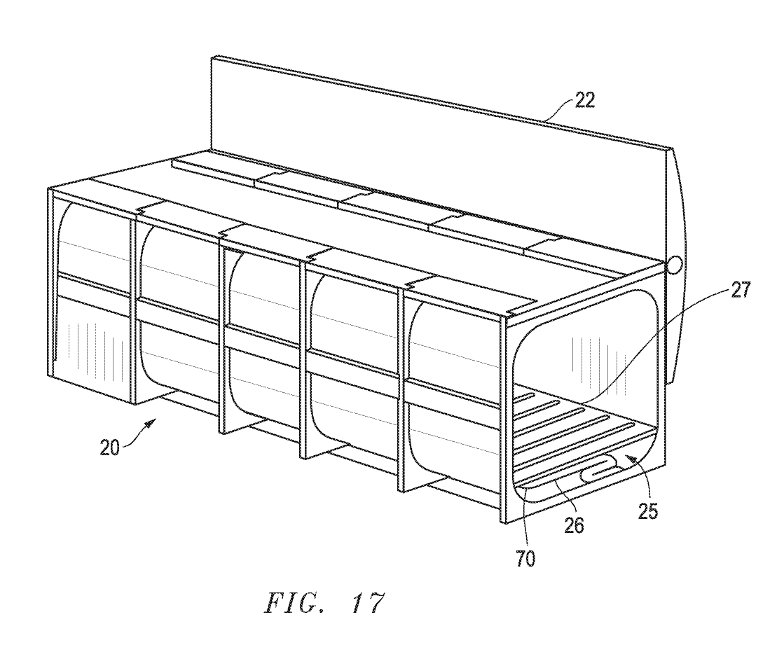

Furthermore, the improved container 20 may include pumps or other means (not illustrated) for loading the mud or mixed material 30 into the container. The top or dome 22 of the improved container 20 may also unfold or open up to allow a more solid material 30 to be loaded, as is illustrated in the exemplary embodiment of FIG. 17, and close when loading of the material 30 is complete and ready for treatment.

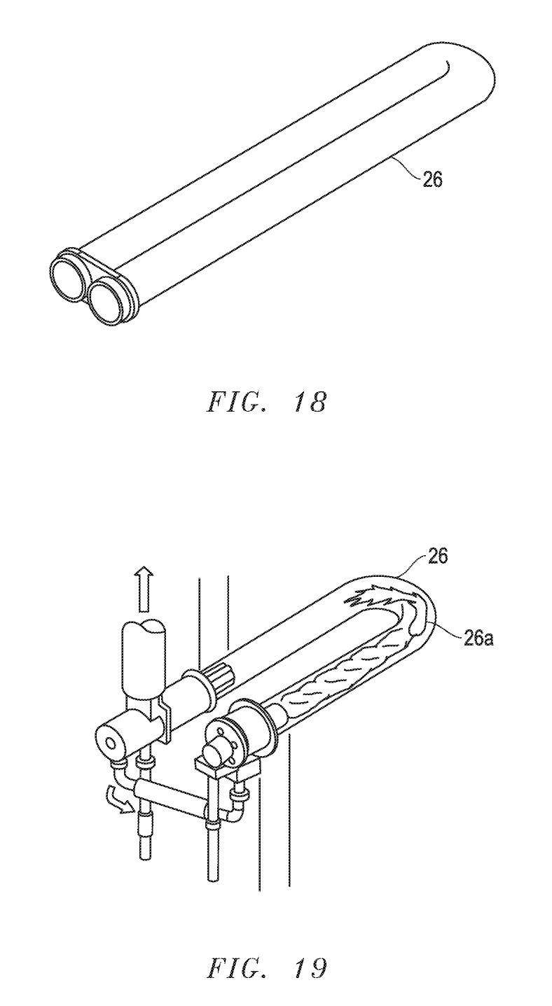

FIGS. 18 and 19 depict perspective views of exemplary embodiments of heating elements 26. In FIG. 19, thermal or heat energy (which may be in the form of a flame or fire 26a) is supplied throughout the interior of the heating element 26.

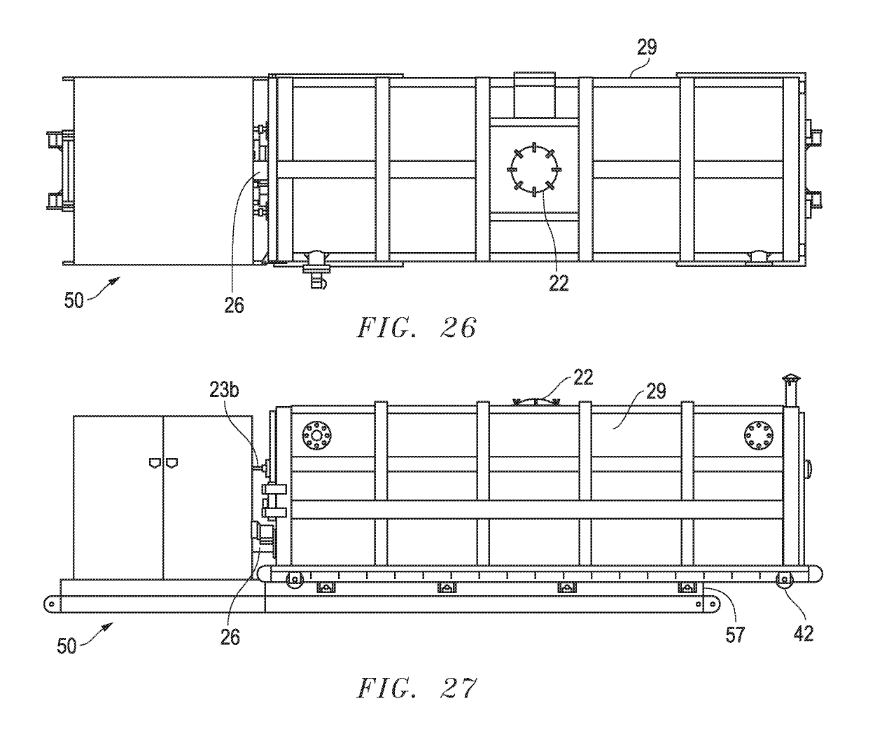

The treatment process begins with obtaining or recovering a volume of drilling mud or other mixed material 30 which is desired to have any volume of water or fluid 32 to be removed. The container 20 is filled with the volume of drilling mud or other material 30, which may be pumped in or loaded in through an open top or dome 22. If loaded through the dome 22, the dome 22 may be subsequently closed after loading. The mud 30 surrounds the internal receiver tube 28 (and optional paddles or mixers 23) when the container 20 is filled. A treatment skid 50 containing a thermal or heating element 26 is aligned with the container 20 through the maneuvering of the hot oil truck 12 or other vehicles/trucks 10 and wheels 42 on the treatment skid 50 and container 20 (see FIG. 26). The treatment skid 50 includes a container catch or safety rail catch 58 (securing or buffering the heating element 26 from damage) may be coupled to the container 20 through latches or couplers 40. A heating element insertion device 52 (which may be an articulable or pivotable arm 52a) may rest on top of a trailer or receptacle 54 as part of the treatment skid 50. After alignment of the treatment skid 50 and the container 20, the heating element insertion device 52 inserts the heating element 26 into a receiver tube 28 within the container 20 (which is also aligned with the heating element 26) through articulation or other movement of the heating element insertion device 52.

Subsequently, a heating source or heating unit 14 (which may be a low NOx unit 14a) supplies thermal energy or heat to the thermal or heating element 26 (a thermal coupler of the like may be used to monitor the temperature and as part of the controls). Said heating source 14 may be located on a hot oil truck 12, but the heating source 14 may also be transported through other vehicular means 10, or be located at a designated, permanent location for treatment. The heating unit 14 heats the heating element 26 to a high enough temperature to allow the water or fluid 32 to turn into water vapor and other gases which leave the internal product 30. By way of example only, the heating element 26 may be at temperature of 350° F. or heat the internal product 30 to a temperature of 350° F. during the treatment process. Additionally, the optional paddle or mixers 23 may agitate, separate and/or breakup the product 30 during the treatment. The remaining contained material 30 becomes land fill acceptable product, treated product or brick 34, which is denser in nature and can be transported to a desired location (for example, a land fill), in the same container 20. The brick 34 may be easily removed from the improved container 20 by opening the door or hatch 21. After heating the drilling mud 30, the heating element 26 may be easily removed from the receiver tube 28 via the heating element insertion device 52 (or arm 52a).

The entire process is done in the same recovery container 20 so gathering product, material or mud 30, transport to treatment and disposal transport is all done in original containment 20. The container 20 is a single unit which may be brought to the location of the mud/material 30 wherein the mud/material 30 is pumped into or loaded into the container 20, heated, processed or otherwise treated within the same said container 20, and then delivered/unloaded to the desired location by the same container 20. The entire process may all be conducted at one singular location. The single unified container 20 is part of the one step process that avoids handling drilling mud or material 30 in multiple and inefficient steps as seen in conventional treatment methods.

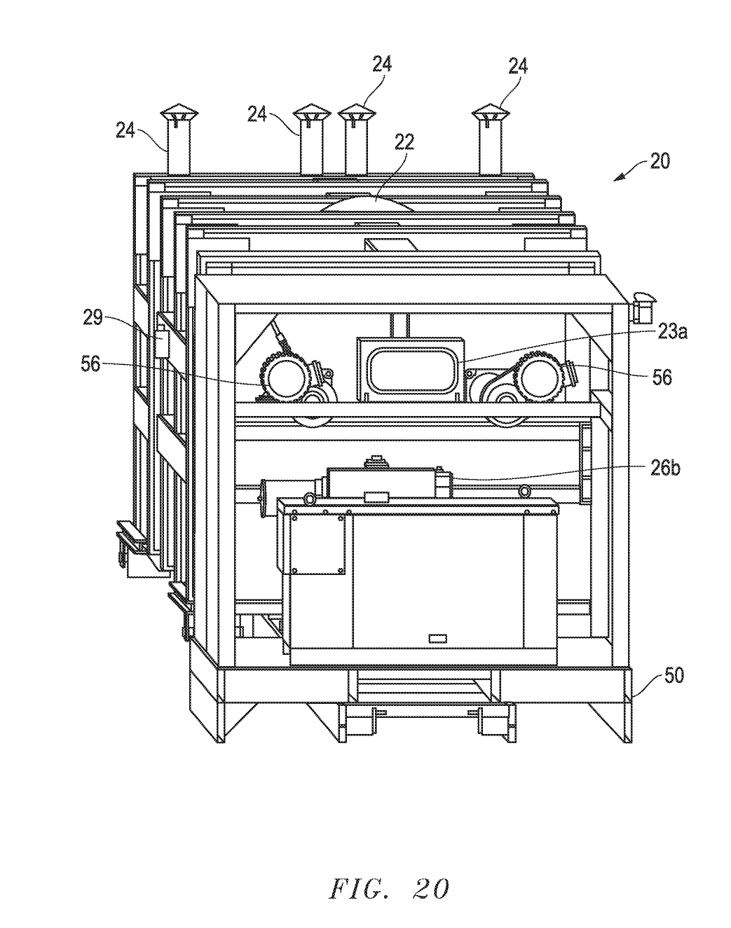

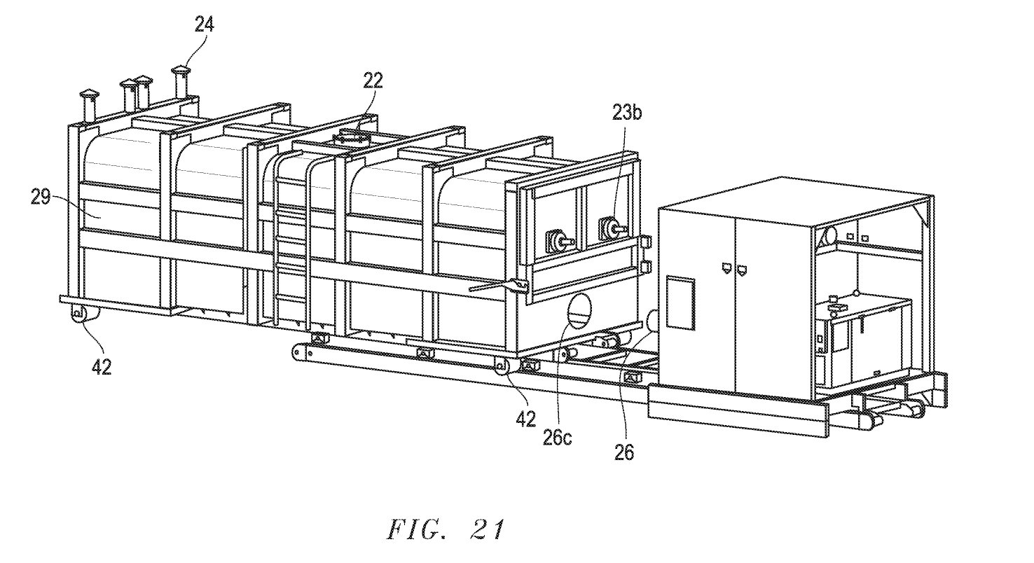

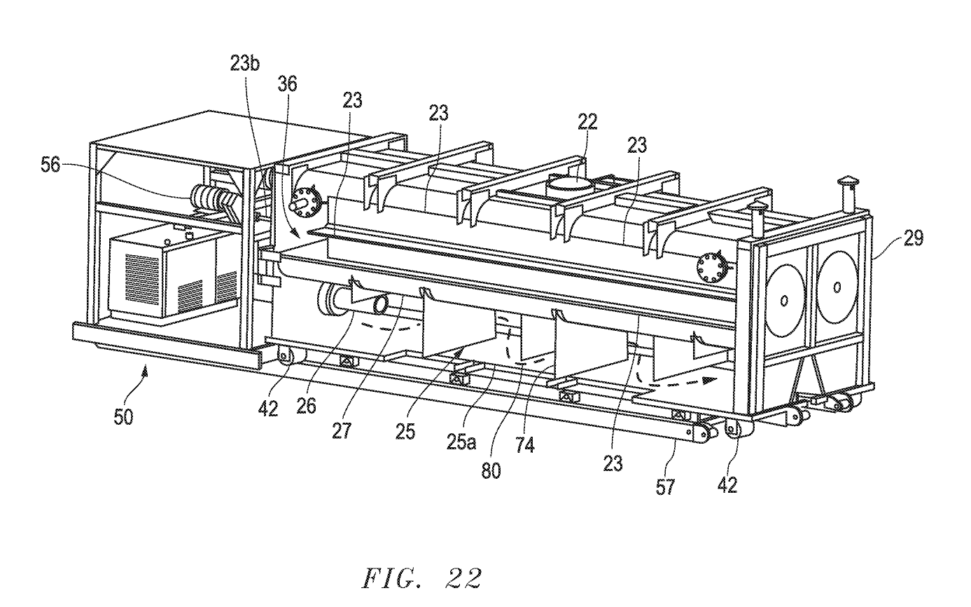

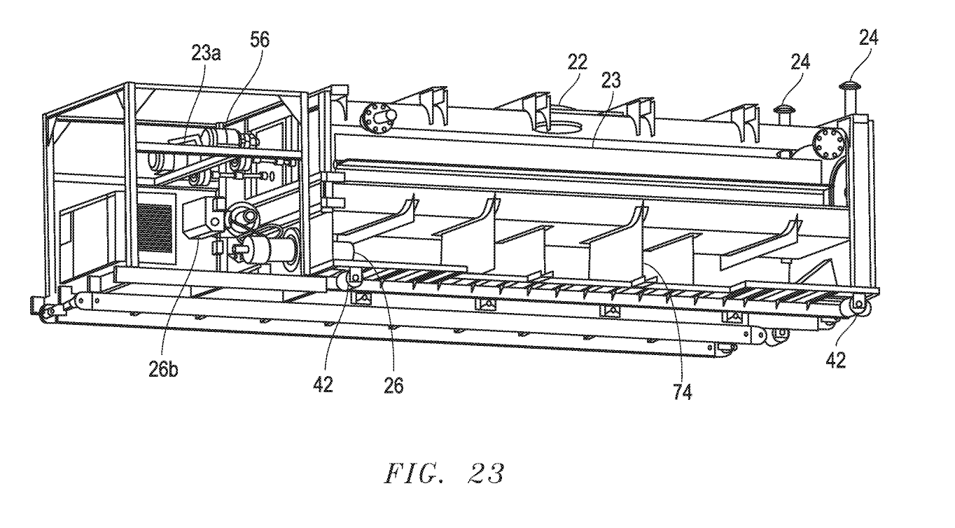

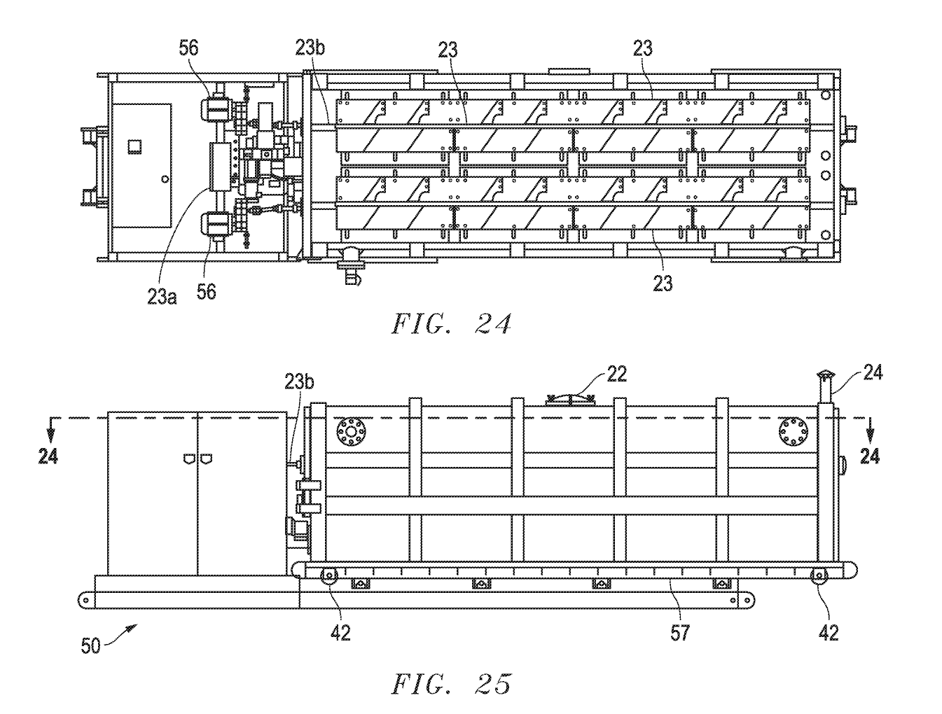

Referring to FIGS. 20-27, another embodiment of the container 20 and skid 50 are represented. The container 20 of FIGS. 20-27 has paddles or mixers 23 mounted on an axle 23b and driven by motor 56. Paddle controls 23a may be used by an operator/controller to adjust the mixing (in this case rotational speed) of the paddles 23. Container 20 includes a floor 27 and a subfloor 25a defining a thermal bed 25 therebetween (and between sidewalls 29). Heating element 26 mounted on skid 50 is inserted into the container 20 through a heating element opening 26c through the container 20. Heating controls 26b may be used for adjustment of the heat or temperature. Baffles 74 may be mounted across the thermal bed 25 between the floor 27 and the subfloor 25a to define a heat path 80 for the heat through (snaking around the baffles 74) the thermal bed 25 and emanating from the heating element 26 for even distribution to the heat. The thermal bed 25 is preferably filled with a volume of thermal fluid or oil 72. The container 20 has wheels 42 for rolling the container 20 on the skid 50.

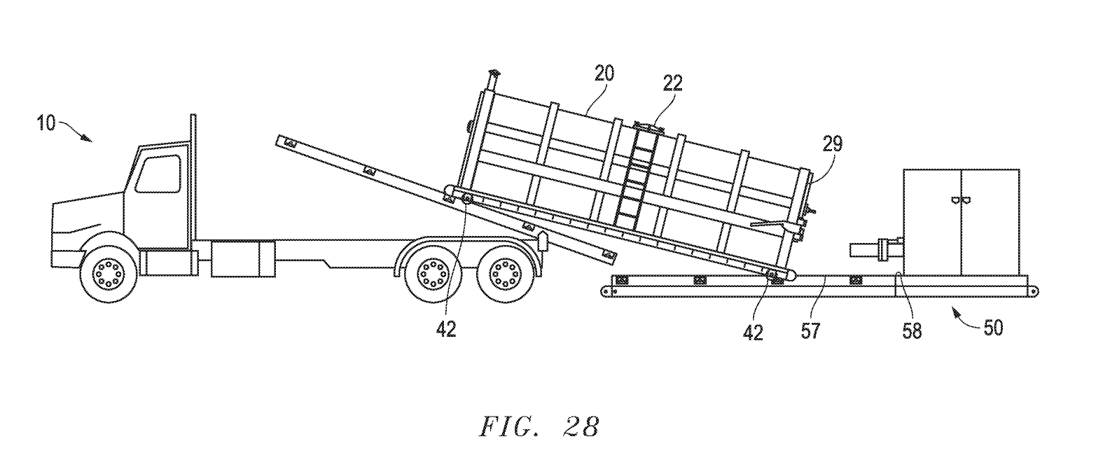

FIG. 28 represents a truck 20 unloading a container 20 onto a skid 50. The container 20 may or may not already contain a volume of mixed material or drilling fluid 30 to be treated. The container 20 is lowered onto the skid using wheels 42 (and for example a winch and cable to counteract gravity). The wheels 42 may be aligned with a tank alignment rail 57. The tank alignment rail 57 may be part of the skid 50. To prevent damage to the heating element 26, the skid may also include a container catch (e.g. a stop plate) 58 protruding above the skid 50 to catch the container 20.

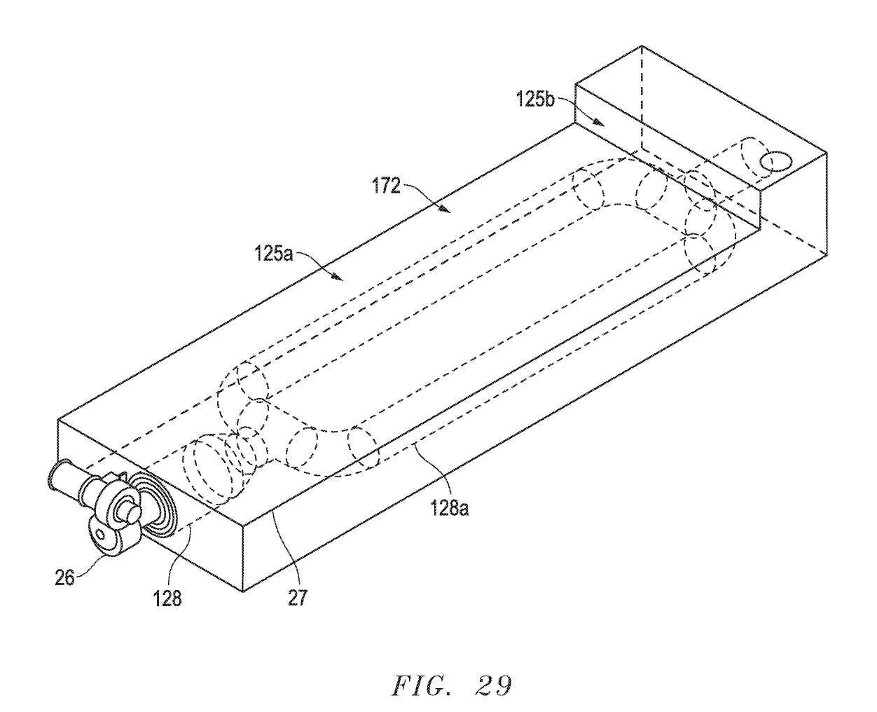

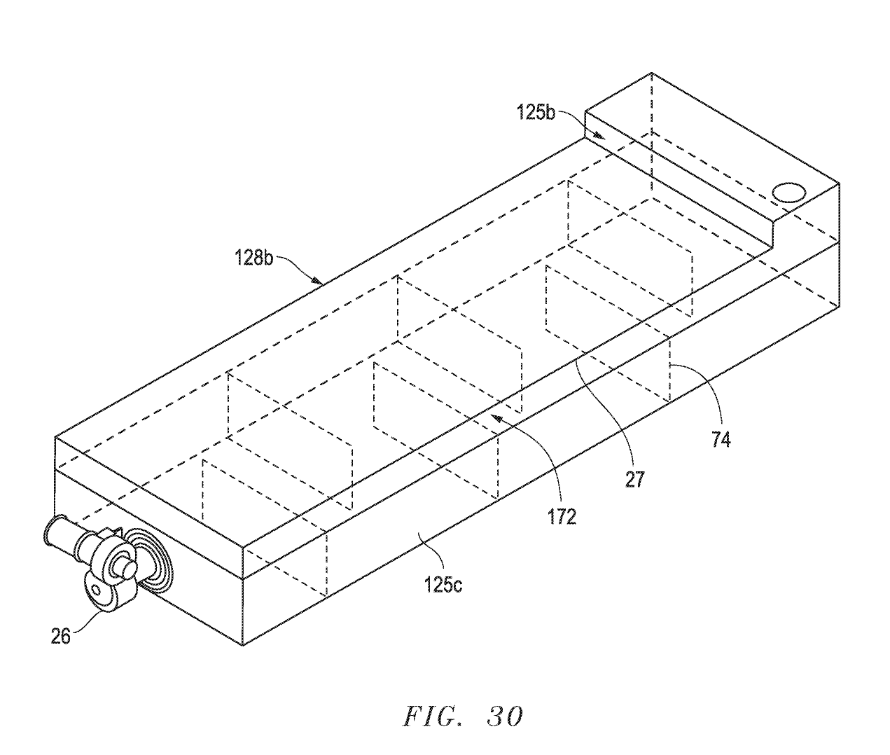

Referring to FIGS. 29-30, another embodiment of a mode of heating a container 20 below of floor 27 is represented. The mode of heating of FIGS. 29-30 utilizes a volume of a salt or molten salt 172 to transfer heat to the mixed material 30. The molten salt 172 may be directly heated (see FIG. 29) or indirectly heated (see FIG. 30).

In direct heating (FIG. 29), a heating element 26 is inserted into a chamber 125a containing molten salt 172 for heating of the chamber 125a. A fire-tube 128 (tube-shaped or other heat transfer shapes) is mounted in and preferably extends as a circuitous tube or coiled tubing 128a running through or across the chamber 125a. The molten salt 172 in the chamber 125a surrounds the fire-tube 128 which may be joined to and heated via heating element 26 for retention of the heat. An expansion chamber 125b may be integrated into the chamber 125a. The container 20 may otherwise be the same as discussed above from floor 27 and above. As discussed above heating element 26 may be mounted on skid 50 and inserted into the container.

The molten salt 172 may alternatively be indirectly heated (see FIG. 30) by a heating element 26 that slides into the thermal bed/burner chamber 125c for heating of a separate layer or chamber 128b containing the volume of molten salt 172. The separate layer or chamber (molten salt chamber) 128b containing the molten salt 172 is lodged in-between the thermal bed 125c containing heating element 126 (directly above it) and below floor 27 bordering the interior 36 of the container 20 containing the mixed material 30 to be heated. An expansion chamber 125b may be integrated into the thermal bed 125c. The thermal bed 125c may include baffles 74 for creating/defining a heat path 80 through the thermal bed 125c. The container 20 may otherwise be the same as discussed above from floor 27 and above. As discussed above heating element 26 may be mounted on skid 50 and inserted into the container.

The volume of molten salt 172 may be used to transfer heat ranging in temperature, by way of example, from 270 degrees Fahrenheit to 1050 degrees Fahrenheit. 900 degrees Fahrenheit could for example be used to heat the mixed material 30 for separating or removing contaminates from the mixed material 30 and heated until sterile. Further, by way of example, the molten salt 172 may be a DYNALENE MS brand molten salt. Hence the embodiments of FIGS. 29-30 may be used to treat contaminated mixed materials 30 on-site which is superior and advantageous to haul the contaminated mixed material 30 off to a disposal site or facility.

While the exemplary embodiments are described with reference to various implementations and exploitations, it will be understood that these exemplary embodiments are illustrative and that the scope of the inventive subject matter is not limited to them. Many variations, modifications, additions and improvements are possible.

Plural instances may be provided for components, operations or structures described herein as a single instance. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

1. A mixed material heating apparatus, comprising:
a container including at least one sidewall and a floor defining an interior, and
wherein the container has an entryway;
a heating element mounted in the container; and
a barrier between said heating element and the interior of the container.

2. The mixed material heating apparatus according to claim 1, wherein the barrier comprises the floor of the container.

3. The mixed material heating apparatus according to claim 1, further comprising a plurality of mixers mounted within the container above the floor.

4. The mixed material heating apparatus according to claim 1, further comprising a skid, wherein the container is separate from the skid in a first position and wherein the container is mounted on the skid in a second position.

5. The mixed material heating apparatus according to claim 1, wherein the container has an exhaust.

6. The mixed material heating apparatus according to claim 1, wherein a thermal bed is defined between the floor and a subfloor of the container below the floor; and a volume of a thermal fluid is contained in the thermal bed.

7. The mixed material heating apparatus according to claim 6, wherein a plurality of baffles are mounted vertically across the thermal bed between the subfloor and the floor.

8. The mixed material heating apparatus according to claim 6, wherein the thermal fluid is a molten salt.

9. A mixed material heating apparatus, comprising:
a container including at least one sidewall and a floor, and having a mixed material entryway;
wherein the container includes a subfloor mounted below the floor;
wherein the container has an exhaust;
a plurality of mixers mounted within the container above the floor;
a skid, wherein the container is separate from the skid in a first position and wherein the container is mounted on the skid in a second position;
a heating element mounted on said skid;
wherein said heating element is mounted in the container between the subfloor and the floor when the container is in the second position.

10. The mixed material heating apparatus according to claim 9, wherein said mixers are paddles.

11. The mixed material heating apparatus according to claim 9, wherein a thermal bed is defined between the floor and the subfloor, and a volume of a thermal fluid is contained in the thermal bed.

12. The mixed material heating apparatus according to claim 11 further comprising a plurality of baffles mounted vertically across the thermal bed between the subfloor and the floor.

13. The mixed material heating apparatus according to claim 9, further comprising a plurality of wheels mounted on the container and rolling on said skid when the container is in the second position.

14. The mixed material heating apparatus according to claim 9 wherein said skid further comprises a tank alignment rail for receiving and guiding the plurality of wheels.

15. The mixed material heating apparatus according to claim 9 wherein said skid further comprises a container catch mounted to said skid and protruding above.

16. The mixed material heating apparatus according to claim 9, further comprising:
a plurality of wheels mounted on the container and rolling on said skid when the container is in the second position;
wherein said skid further comprises a tank alignment rail for receiving and guiding the plurality of wheels;
wherein said skid further comprises a container catch mounted to said skid and protruding above;
wherein a thermal bed is defined between the floor and the subfloor, and a volume of a thermal fluid is contained in the thermal bed; and
a plurality of baffles mounted vertically across the thermal bed between the subfloor and the floor.

17. A method for heating a volume of a mixed material comprising the steps of:
recovering the volume of the mixed material;
filling a container with the volume of the mixed material;
mounting the container on a skid containing a heating element;
aligning the heating element into the container;
heating the volume of the mixed material in the container to a temperature sufficient to remove undesirables from the volume of the mixed material;
exhausting at least a portion of undesirables from the container, and removing a recovered desired product from the container.

18. The method for heating the volume of the mixed material according to claim 17, further comprising the step of agitating the mixed material in the container.

19. The method for heating the volume of the mixed material according to claim 17, further comprising the step of catching the container as it is mounted on the skid and protecting the heating element.

20. The method for heating the volume of the mixed materials according to claim 17, wherein said step of heating the volume of mixed material further comprises introducing a volume of molten salt into a chamber for transferring heat to the volume of mixed material.
